(19) United States
(12) Patent Application Publication
(10) Pub. No.: US 2012/0256818 A1
(43) Pub. Date: Oct. 11, 2012

(54) DISPLAY APPARATUS AND METHOD, STORAGE MEDIUM, AND PROGRAM

(75) Inventor: Yoshihiko Kuroki, Kanagawa (JP)

(73) Assignee: Sony Corporation, Tokyo (JP)

(21) Appl. No.: 13/495,619

(22) Filed: Jun. 13, 2012

Related U.S. Application Data
(63) Continuation of application No. 10/572,044, filed on Mar. 15, 2006.

(30) Foreign Application Priority Data
Jul. 21, 2004 (JP) 2004-212563

(51) Int. Cl. G09G 3/36

(52) U.S. Cl. 345/102

(57) ABSTRACT

The present invention relates to a display apparatus and a method, a storage medium, and a program which cause a so-called “hold-type display apparatus” to display an image that makes it difficult for motion blur and jerkiness to be perceived at a lower frame rate. Display of individual pixels of a screen on an LCD 12 is held in each period of a frame. A display controller 11 controls the display of the LCD 12 so as to time-sequentially increase or time-sequentially reduce the brightness of the screen in each period of a frame. The present invention is applicable to a display apparatus.

### CROSS REFERENCE TO RELATED APPLICATIONS

This is a Continuation Application of the patent application Ser. No. 10/572,044, filed Mar. 15, 2006, which is based on a National Stage Application of PCT/JP2005/011338, filed Jun. 21, 2005, which in turn claims priority from Japanese Application No.: 2004-212563, filed on Jul. 21, 2004, the entire contents of which are incorporated herein by reference.

### TECHNICAL FIELD

The present invention relates to display apparatuses and methods, storage media, and programs. In particular, the present invention relates to a display apparatus and a method, a storage medium, and a program which are suitable for displaying moving images.

### BACKGROUND OF THE INVENTION

The number of frames (fields) displayed by a conventional display apparatus based on an NTSC (National Television System Committee) system or HD (High Definition television) system for one minute is 60 frames (more precisely, 59.94 frames per minute).

The number of frames displayed for one minute will hereinafter be referred to as a “frame rate”.

The frame rate of display apparatuses based on a PAL (Phase Alternating by Line) is 50 frames per minute. Further, the frame rate for movies is 24 frames per minute.

In images displayed with 60 frames to 24 frames per second, moving-image quality deterioration, such as moving image blur (blur) (motion blur) or jerkiness (jerkiness) occurs. In particular, the occurrence of moving-image blur is prominent in a so-called “hold-type display apparatus” in which display is held during the period of each frame.

Conventionally, there is a technology in which comparison is performed with previous display data and, for a pixel having any change, display data emphasized to have the amount of change greater than or equal to that change is written to the pixel, so as to cause a change greater than or equal to a value corresponding to the initial display data. Further, based on the optical response of the liquid crystal at this point, the lighting timing and the lighting period of a light source is controlled for each area of an illumination device having multiple areas (e.g., refer to Patent Document 1).

There is also a liquid crystal display apparatus in which the light of a florescent lamp having fluorescent-material films for emitting red, green, and blue light is controlled, by a lighting circuit, through pulse-width modulation lighting and video signals are written to a liquid-crystal panel so as to cause the fluorescent lamp to serve as a backlight for the liquid crystal panel. Further, with the green-light-emitting fluorescent material film provided in the fluorescent lamp, a period of time in which the amount of light reaches one tenth of a lighting period after the light is turned off becomes 1 mm second or less (e.g., refer to Patent Document 2).
[Patent Document 1] Japanese Unexamined Patent Application Publication No. 2001-125067
[Patent Document 2] Japanese Unexamined Patent Application Publication No. 2002-105447

### BRIEF SUMMARY OF THE INVENTION

### Problems to be Solved by the Invention

When a direct-viewing or reflective LCD display apparatus serving as a hold-type display apparatus displays an image (an image object) that moves on its display screen, moving-image blur is perceived. The moving-image blur is caused by a displacement in an image formed on the retinas, which displacement is referred to as a retinal slip (retinal slip) in tracking vision in which the eyes are caused to track an image (an image object) that moves on the display screen (Shikaku Jouho Shori Handbook, edited by Nihon Shikaku Gakkai, Asakura Shoten, pp 393). From typical images that are displayed at a frame rate of 60 or less per second and that include a moving image object, a large amount of motion blur is perceived.

In order to reduce such motion blur, it is also considered that light is emitted in a pulsed manner in a shorter period of time than a period in which one frame is displayed (i.e., in a rectangular-wave form relative to time). With such display, however, in fixed vision in which a displayed image is seen with a fixed line of vision (point of vision), jerkiness in which image motion is discretely seen (i.e., is seen in a jerky manner) is perceived with respect to an image object that moves quickly.

The present invention has been made in view of such situations, and an object of the present invention is to cause the so-called “hold-type display apparatus”, in which display is held during the period of each frame, to display an image that makes it difficult for motion blur and jerkiness to be perceived at a smaller frame rate.

### Means for Solving the Problems

A display apparatus of the present invention includes displaying means for holding display of individual pixels of a screen in each period of a frame, and display controlling means for controlling the display of the displaying means so as to time-sequentially increase brightness of the screen or time-sequentially reduce the brightness of the screen in each period of the frame.

The display controlling means can include synchronization-signal generating means for generating a synchronization signal for synchronization with the frame; sequence-signal generating means for generating, based on the synchronization signal, a sequence signal that time-sequentially increases or time-sequentially decreases in each period of the frame; and brightness controlling means for controlling the brightness of the screen, based on the sequence signal.

By controlling brightness of a light source, the display controlling means can control the display of the displaying means so as to time-sequentially increase the brightness of the screen or time-sequentially reduce the brightness of the screen.

The light source can include an LED (light emitting diode).

By controlling the brightness of the light source by a PWM (pulse width modulation) system, the display controlling means can control the display of the displaying means so as to time-sequentially increase the brightness of the screen or time-sequentially reduce the brightness of the screen.

The display apparatus can further include motion-amount detecting means for detecting an amount of motion of an image displayed; storing means for storing a light-emission intensity that serves as a reference; and determining means for determining, based on the stored light-emission intensity and the detected amount of motion, a characteristic value defining a characteristic for time-sequentially increasing the brightness of the screen or time-sequentially reducing the brightness of the screen, with a constant light-emission intensity for the frame. The display controlling means can control the display of the displaying means so as to time-sequentially increase the brightness of the screen or time-sequentially reduce the brightness of the screen in each period of the frame, based on the characteristic value.

Based on the spectral luminous efficiency of human eyes, by time-sequentially increasing or time-sequentially reducing brightness of each of the three primary colors in each period of the frame, the display controlling means can control the display so as to time-sequentially increase the brightness of the screen or time-sequentially reduce the brightness of the screen.

The display controlling means can include correcting means for correcting, based on the spectral luminous efficiency of human eyes, a characteristic value for each of the three primary colors of light so as to cancel out a change in human eye sensitivity according to a brightness change and relative to each of the three primary colors of light. The characteristic value defines a characteristic for time-sequentially increasing the brightness of the screen or time-sequentially reducing the brightness of the screen. Based on the corrected characteristic value, the display controlling means can control the display so as to time-sequentially increase the brightness of the screen or time-sequentially reduce the brightness of the screen, by time-sequentially increasing or time-sequentially reducing the brightness of each of light sources having the three primary colors.

A display method of the present invention is directed to a display method for a display apparatus in which display of individual pixels of a screen is held in each period of a frame. The method includes a display controlling step of controlling the display so as to time-sequentially increase brightness of the screen or time-sequentially reduce the brightness of the screen in each period of the frame.

A program in a storage medium of the present invention is directed to a program for display processing for a display apparatus in which display of individual pixels of a screen is held in each period of a frame. The program includes a display controlling step of controlling the display so as to time-sequentially increase brightness of the screen or time-sequentially reduce the brightness of the screen in each period of the frame.

A program of the present invention causes a computer, which controls a display apparatus in which display of individual pixels of a screen is held in each period of a frame, to execute a display controlling step of controlling the display so as to time-sequentially increase brightness of the screen or time-sequentially reduce the brightness of the screen in each period of the frame.

According to the display apparatus and the method, the storage medium, and the program of the present invention, display is controlled so as to time-sequentially increase the brightness of the screen or time-sequentially reduce the brightness of the screen in each period of a frame.

The display apparatus may be an independent apparatus and may be, for example, a displaying block of an information processing apparatus.

### Advantages of the Invention

As described above, according to the present invention, an image can be displayed.

According to the present invention, the so-called “hold-type display apparatus” can display an image that makes it difficult for motion blur and jerkiness to be perceived at a lower frame rate.

### BRIEF DESCRIPTION OF THE DRAWINGS

FIG. 1 is a block diagram showing the configuration of one embodiment of a display apparatus according to the present invention.

FIG. 2 is a flow chart illustrating processing for brightness control.

FIG. 3 is a graph showing an example of a waveform signal.

FIG. 4 is a graph showing an example of the waveform signal.

FIG. 5 is a graph showing an example of the waveform signal.

FIG. 6 is a diagram showing an example of the configuration of a waveform-signal generating circuit.

FIG. 7 is a diagram showing an example of an input signal Vᵢ(t).

FIG. 8 is a diagram showing an example of an output signal Vₒ(t).

FIG. 9 is a diagram showing a more detailed example of the output signal Vₒ(t).

FIG. 10 is a diagram showing an example of a rectification signal Vₛ(t).

FIG. 11 is a block diagram showing another configuration of one embodiment of the display apparatus according to the present invention.

FIG. 12 is a flow chart illustrating another processing for brightness control.

FIG. 13 is a block diagram showing still another configuration of one embodiment of the display apparatus according to the present invention.

FIG. 14 is a block diagram showing still another configuration of one embodiment of the display apparatus according to the present invention.

FIG. 15 is a graph showing an example of spectral-luminous-efficiency data.

FIG. 16 is a block diagram showing still another configuration of one embodiment of the display apparatus according to the present invention.

FIG. 17 is a block diagram showing yet another configuration of one embodiment of the display apparatus according to the present invention.

### REFERENCE NUMERALS

11 display controller, 12 LCD, 13 LED backlight, 21 vertical-synchronization-signal generator, 22 waveform-data generator, 24 DAC, 25 current controller, 31 magnetic disk, 32 optical disk, 33 magneto-optical disk, 34 semiconductor memory, 51 display controller, 71 vertical-synchronization-signal generator, 72 motion-amount detector, 74 waveform-data generator, 75 waveform-characteristic determining unit, 81 reference light-emission-intensity storage unit, 101 display controller, 111 PWM drive-current generator, 131 display controller, 132 red LED backlight, 133 green LED backlight, 134 blue LED backlight, 141 waveform-data generator, 142-1 to 142-3 DACs, 143-1 to 143-3 current controllers, 151 spectral-luminous-efficiency data table, 152 characteristic-value correcting unit, 171 display controller, 172 LCD, 173 shutter, 174 lamp, 181 waveform-data generator, 182 DAC, 201 display controller, 202 LED display, 222-1 to 222-3 LED display controllers.

### DETAILED DESCRIPTION OF THE INVENTION

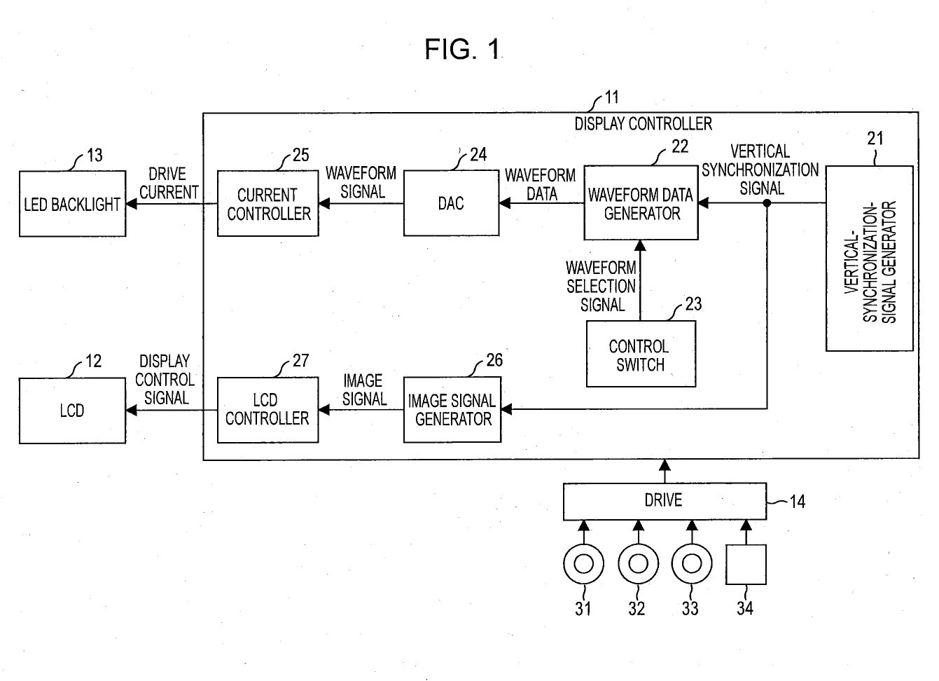

FIG. 1 is a block diagram showing the configuration of one embodiment of a display apparatus according to the present invention. A display controller 11 controls the display of an LCD (liquid crystal display) 12, which is one example of a display device, and the light emission of an LED (light emitting diode) backlight 13, which is one example of a light source for supply light to the display device. The display controller 11 is accomplished by a dedicated circuit including an ASIC (application specific integrated circuit) and so on, a programmable LSI such as a FPGA (field programmable gate array), or a general-purpose microprocessor for executing a control program.

Under the control of the display controller 11, the LCD 12 displays an image. The LED backlight 13 includes one or multiple LEDs and emits light under the control of the display controller 11.

For example, the LED backlight 13 includes one or multiple red LEDs for emitting red light, one or multiple green LEDs for emitting green light, and one or multiple blue LEDs for emitting blue light. For example, the LED backlight 13 may also include one or multiple LEDs for emitting light containing red, green, and blue.

Light emitted from the LED backlight 13 is uniformly diffused by a diffusion film, not shown, and is incident, via the LCD 12, on the eyes of a person who is viewing the LCD 12.

In other words, out of light incident from the LED backlight 13, pixels of the LCD 12 permit the passage of predetermined-wavelength light (color light) having a predetermined intensity (a predetermined ratio). The predetermined-intensity color light that has passed through the pixels of the LCD 12 is incident on the eyes of a person who is viewing the LCD 12, so that the person who is viewing the LCD 12 perceives an image displayed on the LCD 12.

The display controller 11 includes a vertical-synchronization-signal generator 21, a waveform-data generator 22, a control switch 23, a DAC (Digital to Analog Converter) 24, a current controller 25, an image-signal generator 26, and an LCD controller 27.

The vertical-synchronization-signal generator 21 generates a vertical synchronization signal for synchronization with each frame of a moving image to be displayed and supplies the generated vertical synchronization signal to the waveform-data generator 22 and the image-signal generator 26. The control switch 23 supplies a waveform selection signal for giving an instruction for selecting a waveform, and based on the waveform selection signal, the waveform-data generator 22 generates waveform data specifying the brightness of the LED backlight 13, in synchronization with the vertical synchronization signal. For example, the waveform-data generator 22 generates waveform data for time-sequentially changing the brightness of the LED backlight 13. For example, the waveform-data generator 22 generates waveform data for maintaining the brightness of the LED backlight 13. The waveform-data generator 22 supplies the generated waveform data to the DAC 24.

For example, the waveform-data generator 22 stores pre-obtained waveform-data values corresponding to the elapse of time and sequentially outputs the pre-stored waveform-data values in accordance with time elapsed from the start time of a frame.

The waveform-data generator 22 may store an arithmetic expression describing waveform-data values corresponding to the elapse of time. Further, based on the stored arithmetic expression, the waveform-data generator 22 may generate waveform data by determining waveform-data values, in accordance with time elapsed from the start time of a frame.

The control switch 23 is operated by a user and supplies a waveform selection signal corresponding to a user operation to the waveform-data generator 22. For example, in accordance with the a user operation, the control switch 23 supplies, to the waveform-data generator 22, a waveform selection signal for giving an instruction for selecting a waveform for maintaining the brightness of the LED backlight 13 or supplies, to the waveform-data generator 22, a waveform selection signal for giving an instruction for selecting a waveform for time-sequentially changing the brightness of the LED backlight 13.

The DAC 24 performs digital-to-analog conversion on the waveform data, which is digital data, supplied from the waveform-data generator 22. That is, the DAC 24 performs digital-to-analog conversion on the waveform data, which is digital data, and supplies the resulting waveform signal, which is a voltage analog signal, to the current controller 25. The voltage value of the waveform signal output from the DAC 24 corresponds to the value of the waveform data input to the DAC 24.

The current controller 25 converts the waveform signal, which was supplied from the DAC 24 and is a voltage analog signal, into drive current and supplies the converted drive current to the LED backlight 13. The current value of the drive current supplied from the current controller 25 to the LED backlight 13 corresponds to the voltage value of the waveform signal input to the current controller 25.

When the current value of the drive current increases, the LED backlight 13 emits brighter light (the brightness increases), and when the current value of the drive current decreases, the LED backlight 13 emits darker light (the brightness decreases).

That is, in accordance with the waveform data output from the waveform-data generator 22, the brightness of the LED backlight 13 varies. For example, when the waveform-data generator 22 outputs waveform data having a maintained value, the LED backlight 13 emits light at maintained brightness.

On the other hand, when the waveform-data generator 22 outputs waveform data that decreases time-sequentially or that increases time-sequentially, the LED backlight 13 emits light so that the brightness decreases time-sequentially or the brightness increases time-sequentially.

In particular, when the waveform-data generator 22 outputs, based on the vertical synchronization signal, waveform data that decreases time-sequentially or increases time-sequentially in each period in which one frame is displayed on the LCD 12, the LED backlight 13 emits light so that the brightness decreases time-sequentially or the brightness increases time-sequentially in each period in which one frame is displayed.

The image-signal generator 26 generates image signals for displaying a predetermined image. For example, the image-signal generator 26 is a computer-graphics video-signal generating device for generating image signals for displaying the so-called “computer graphics”.

More specifically, the image-signal generator 26 generates image signals for displaying a predetermined image, in synchronization with the vertical synchronization signal, supplied from the vertical-synchronization-signal generator 21, for synchronization with each frame of a moving image to be displayed. The image-signal generator 26 supplies the generated image signals to the LCD controller 27.

Based on the image signals supplied from the image-signal generator 26, the LCD controller 27 generates a display control signal for causing the LCD 12 to display an image and supplies the generated display control signal to the LCD 12. Thus, the LCD 12 displays an image corresponding to the image signals generated by the image-signal generator 26.

That is, when the image-signal generator 26 generates image signals for displaying a predetermined image for each frame in synchronization with the vertical synchronization signal supplied from the vertical-synchronization-signal generator 21, the LCD 12 display an image for each frame, the image being synchronized with the vertical synchronization signal. On the other hand, as described above, when the waveform-data generator 22 outputs, based on the vertical synchronization signal, waveform data that time-sequentially decreases or time-sequentially increases in each period in which one frame is displayed, the LED backlight 13 emits light so that the brightness time-sequentially decreases or the brightness time-sequentially increases in synchronization with each frame to be displayed on the LCD 12 in each period in which one frame is displayed.

With this arrangement, even when each pixel of the LCD 12 causes color with a constant ratio and in constant color to pass therethrough based on one pixel value supplied as the display control signal in a period in which one frame is displayed, the light incident on the LCD 12 decreases time-sequentially or increases time-sequentially in the period of one frame. Thus, The intensity of light incident on the eyes of a person viewing the LCD 12 decreases time-sequentially or increases time-sequentially in the period of one frame.

As a result, even when a moving image object is displayed at a lower frame rate, this arrangement makes it difficult for a person viewing the LCD 12 to perceive motion blur and jerkiness.

A drive 14 is connected to the display controller 11, as needed. The drive 14 reads a program or data recorded in a magnetic disk 31, an optical disk 32, a magneto-optical disk 33, or a semiconductor memory 34, which is loaded into the drive 14, and supplies the read program or data to the display controller 11. The display controller 11 can execute the program supplied from the drive 14.

The display controller 11 may obtain a program through a network, which is not shown.

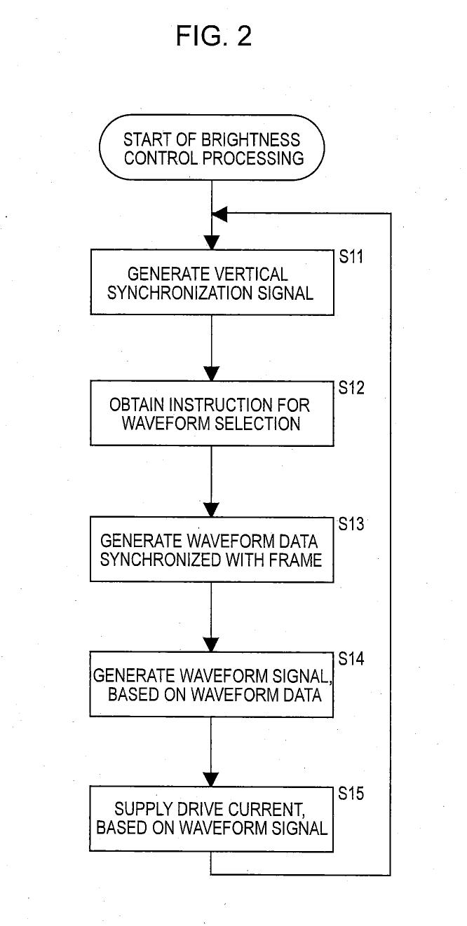

Next, brightness control processing performed by the display controller 11, which executes a control program, to time-sequentially reduce or time-sequentially increase the brightness will be described with reference to a flow chart shown in FIG. 2. In practice, individual steps described below with reference to the flow chart are processed in parallel.

In step S11, the vertical-synchronization-signal generator 21 generates a vertical synchronization signal for synchronization with each frame of a moving image to be displayed. For example, in step S11, the vertical-synchronization-signal generator 21 generates a vertical synchronization signal for synchronization with each frame of a moving image constituted by 24 to 500 frames per second.

In step S12, the waveform-data generator 22 obtains a waveform selection signal corresponding to a user operation and supplied from the control switch 23, to thereby obtain an instruction for selecting a waveform for time-sequentially reducing or time-sequentially increasing the brightness in each period in which one frame is displayed.

In step S13, based on the instruction for selecting a waveform obtained in step S12 and the vertical synchronization signal generated in the processing in step S11, the waveform-data generator 22 generates waveform data for time-sequentially reducing the brightness or time-sequentially increasing the brightness in synchronization with a frame in each period in which one frame is displayed.

For example, for each frame, the waveform-data generator 22 generates waveform data for time-sequentially reducing the brightness or time-sequentially increasing the brightness in a period of 25% of the length of the period of one frame. More specifically, for example, when a moving image constituted by 500 frames is displayed per second, the period of one frame is 2 [ms]. Thus, for each frame, the waveform-data generator 22 generates waveform data for time-sequentially reducing the brightness or time-sequentially increasing the brightness in 500 [μs], which is 25% of the length of the period of one frame.

In step S14, the DAC 24 performs digital-to-analog conversion on the waveform data, and based on the generated waveform data, the DAC 24 generates a waveform signal corresponding to the waveform data. That is, when waveform data for time-sequentially reducing or time-sequentially increasing the brightness is displayed is generated in synchronization with a frame in each period in which one frame, in step S14, the DAC 24 generates a waveform signal for time-sequentially reducing or time-sequentially increasing the brightness in synchronization with the frame in each period in which one frame is displayed.

In step S15, based on the generated waveform signal, the current controller 25 supplies drive current to the LED backlight 13. The process then returns to step S11 and the processing described above is repeated. More specifically, when a waveform signal for time-sequentially reducing or time-sequentially increasing the brightness is generated in synchronization with a frame in each period in which one frame is displayed, in step S15, the current controller 25 supplies, to the LED backlight 13, drive current for time-sequentially reducing or time-sequentially increasing the brightness of the LED backlight 13 in synchronization with the frame in each period in which one frame is displayed.

When the current value of the drive current increases, the brightness of the LED backlight 13 increases, and when the current value of the drive current decreases, the brightness of the LED backlight 13 decreases. When the brightness of the LED backlight 13 is time-sequentially reduced in synchronization with a frame in each period in which one frame is displayed, the current controller 25 supplies, to the LED backlight 13, drive current for time-sequentially reducing the current value in synchronization with a frame in each period in which one frame is displayed. Similarly, when the brightness of the LED backlight 13 is time-sequentially increased in synchronization with a frame in each period in which one frame is displayed, the current controller 25 supplies, to the LED backlight 13, drive current for time-sequentially increasing the current value in synchronization with the frame in the period in which one frame is displayed.

That is, for example, a waveform signal for time-sequentially reducing the brightness is supplied to the current controller 25 in synchronization with a frame in each period in which one frame is displayed and drive current for time-sequentially reducing the current value is supplied to the LED backlight 13 in synchronization with a frame in each period in which one frame is displayed. For example, a waveform signal for time-sequentially increasing the brightness is supplied to the current controller 25 in synchronization with a frame in each period in which one frame is displayed and drive current for time-sequentially increasing the current value is supplied to the LED backlight 13 in synchronization with a frame in each period in which one frame is displayed.

The waveform-data generator 22 generates waveform data for generating a waveform signal for time-sequentially increasing the brightness in synchronization with a frame in each period in which one frame is displayed.

With this arrangement, even when a moving image object is displayed at a lower frame rate, an image that makes it difficult for motion blur and jerkiness to be perceived can be displayed.

The brightness can be maintained. In this case, in step S12, the waveform data generator 22 obtains a waveform selection signal for giving an instruction for selecting a waveform for maintaining the brightness of the LED backlight 13 and, in step S13, the waveform data generator 22 generates waveform data for maintaining the brightness. Since the DAC 24 generates a waveform signal for maintaining the brightness in step S14, the current controller 25 supplies drive current for maintaining the brightness of the LED backlight 13, i.e., drive current whose current value is maintained, to the LED backlight 13 in step S15.

For example, the user operates the control switch 23 to cause the control switch 23 to output, in the case of displaying a moving image, a waveform selection signal for giving an instruction for selecting a waveform signal for time-sequentially reducing or time-sequentially increasing the brightness in each period in which one frame is displayed and to output, in the case of displaying a still image, a waveform selection signal for giving an instruction for selecting a waveform for maintaining the brightness.

With this arrangement, when a moving image is displayed, an image that makes it difficult for motion blur and jerkiness to be perceived is displayed, and when a still image is displayed, an image that makes it difficult for flicker to be perceived is displayed.

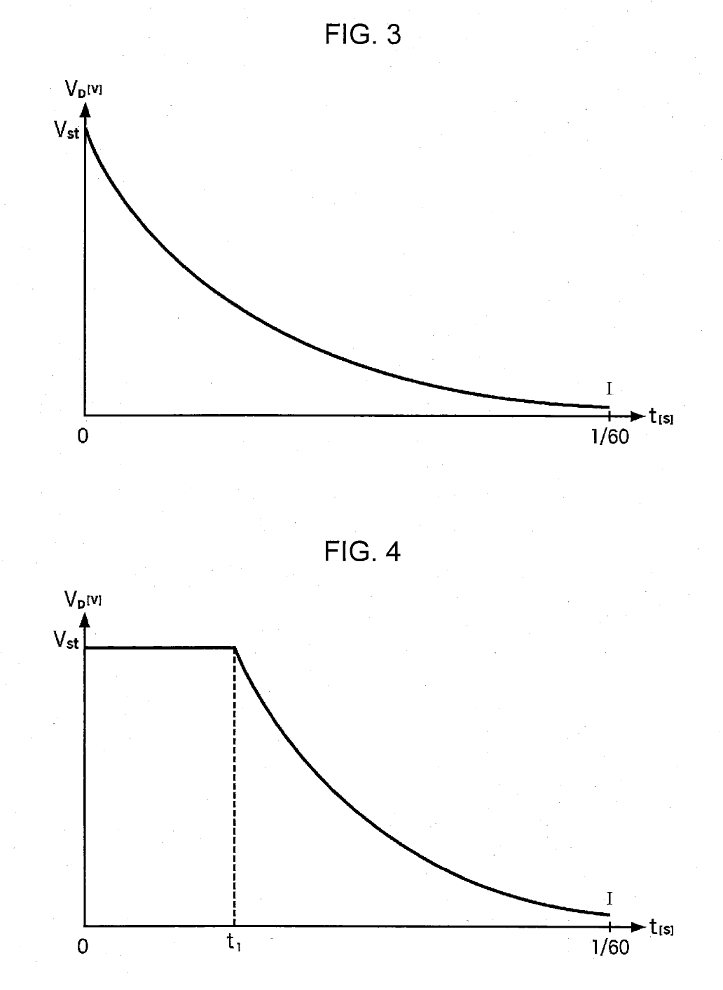

FIGS. 3 to 5 are graphs each showing, in a case in which a moving image is constituted by 60 frames per second, an example of the waveform signal for time-sequentially reducing or time-sequentially increasing the brightness in each period in which one frame is displayed.

In FIGS. 3 to 5, the horizontal direction indicates time that elapses from the left side toward the right side. Time 0 in FIGS. 3 to 5 indicates the start time of one frame.

In FIGS. 3 to 5, the horizontal direction indicates a voltage value V_{D} [V] of a waveform signal and the upper side in each figure indicates a larger voltage value.

FIG. 3 is a graph showing an example of a waveform signal for time-sequentially reducing the brightness from the start time of a frame. The waveform signal that is shown in FIG. 3 and that has a voltage value Vₛₜ [V] at the start time of the frame decreases exponentially according to the elapse of time and reaches substantially 0 [V] at a point when 1/60th of a second elapses from the start time of the frame, i.e., at the end time of the frame.

When the waveform signal shown in FIG. 3 is generated, the LED backlight 13 emits light with the highest intensity at the start time of the frame and light emitted from the LED backlight 13 decays exponentially according to the elapse of time. At the end time of the frame, the LED backlight 13 emits almost no light.

A property displaying that the amount sensation is proportional to the logarithm of stimulation is knows as Fechner's law (Shikaku Jouho Shori Handbook, edited by Nihon Shikaku Gakkai, Asakura Shoten, pp 140). Thus, it can be said that, when the LED backlight 13 is designed to emit light so that it decays exponentially according to the elapse of time, the amount of sensation, i.e., the sense of brightness of a person who is viewing the display apparatus, changes linearly.

FIG. 4 is a graph showing another example of the waveform signal for time-sequentially reducing the brightness from the start time of a frame. The waveform signal that is shown in FIG. 4 and that has a voltage value Vₛₜ [V] at the start time of the frame is constant, for example, until time t₁, which is time when 1/180th of a second elapses from the start time of the frame. From time t₁, the voltage value decreases exponentially according to the elapse of time and reaches substantially 0 [V] at the end time of the frame. In a period from time t₁ to the end time of the frame, the waveform signal shown in FIG. 4 decays more rapidly, compared to the case shown in FIG. 3.

When the waveform signal shown in FIG. 4 is generated, the LED backlight 13 emits the strongest and constant light, in a period from the start time of the frame to time t₁. After time t₁, light emitted from the LED backlight 13 decays exponentially according to the elapse of time. At the end time of the flame, the LED backlight 13 emits almost no light.

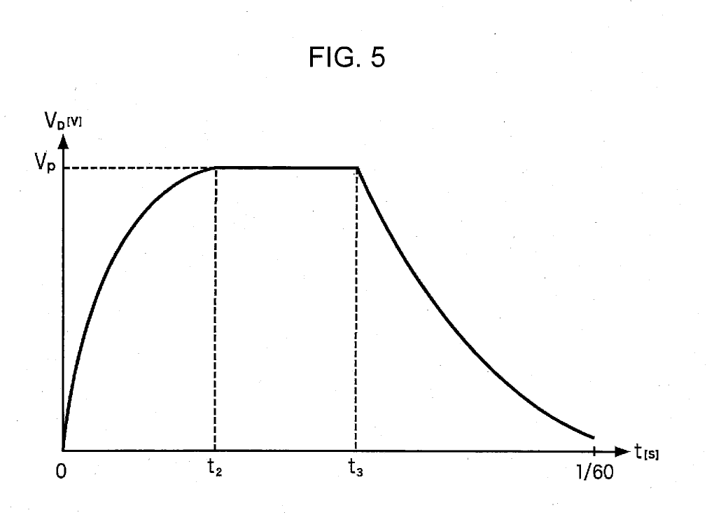

FIG. 5 is a graph showing still another example of the waveform signal for time-sequentially increasing the brightness from the start time of a frame and then time-sequentially reducing the brightness. The waveform signal that is shown in FIG. 5 and that has a voltage value 0 [V] at the start time of the frame gradually increases exponentially, for example, to time t₂ when 1/180th of a second elapses from the start time of the frame. The waveform signal is at Vₚ [V] at time t₂.

In FIG. 5, time t₃ is time when 1/90th of a second has elapsed from the start time of a frame. The waveform signal shown in FIG. 5 is constant from time t₂ to time t₃. Further, the waveform signal decreases exponentially from time t₃ according to the elapse of time and reaches substantially 0 [V] at the end time of the frame.

When the waveform signal shown in FIG. 5 is generated, the LED backlight 13 emits almost no light at the start time of the frame, and light emitted from the LED backlight 13 gradually increases exponentially according to the elapse of time from the start time of the frame to time t₂. The LED backlight 13 emits constant light with the highest intensity in a period from time t₂ to time t₃. Further, after time t₃, light emitted from the LED backlight 13 decays exponentially according to the elapse of time. At the end time of the flame, the LED backlight 13 emits almost no light.

Naturally, the LED backlight 13 may emit strong light in the vicinity of the start time of a frame.

Although the description has been given of a case in which the brightness of the LED backlight 13 is exponentially reduced according to the elapse of time or exponentially and gradually increased, the present invention is not limited thereto. The brightness can be time-sequentially increased or time-sequentially reduced, for example, can be linearly reduced or increased according to the elapse of time.

Next, a display device having a simpler configuration will be described.

The waveform-data generator 22 and the DAC 24 shown in FIG. 1 can be replaced with a waveform-signal generating circuit having a simpler configuration. For example, the waveform-signal generating circuit can be constituted by a differentiating circuit and a rectifying circuit.

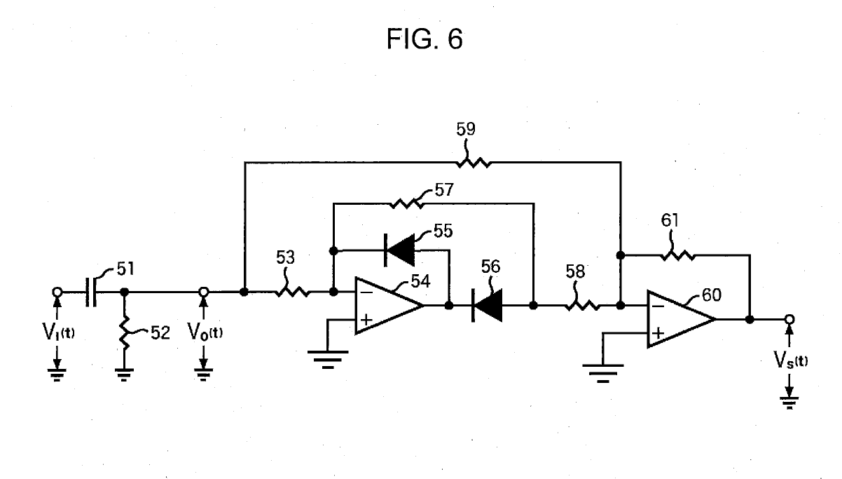

FIG. 6 is a diagram showing an example of the configuration of the waveform-signal generating circuit, which substitutes the waveform-data generator 22 and the DAC 24 shown in FIG. 1.

A capacitor 51 and a resistor 52 in the waveform-signal generating circuit shown in FIG. 6 form the so-called “differentiating circuit”. An input signal Vᵢ(t) that is inverted in synchronization with the vertical synchronization signal is input to the waveform-signal generating circuit.

One end of the capacitor 51 is connected to an input terminal to which the input signal Vᵢ(t) is supplied, and the other end of the capacitor 51 is connected to one end of the resistor 52. The other end of the resistor 52 is connected to ground. A voltage across the resistor 52 is supplied, as an output signal Vₒ(t) of the differentiating circuit, to the rectifying circuit at the next stage of the waveform-signal generating circuit.

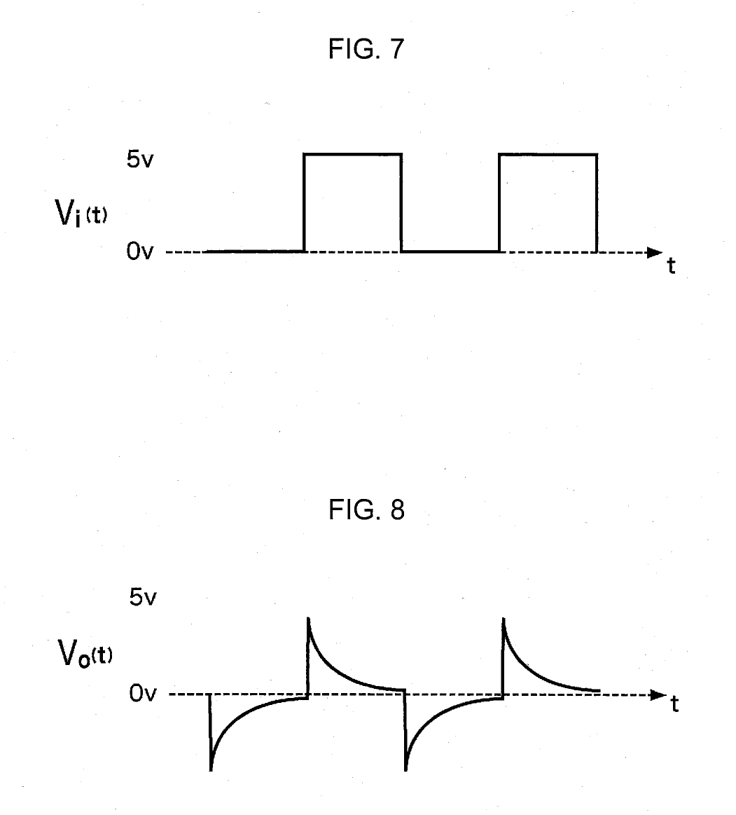

FIG. 7 is a diagram showing an example of the input signal Vᵢ(t). For example, when frames change so that the value of the input signal Vᵢ(t) becomes 0 [V] in the period of one frame, becomes 5 [V] in the period of a next frame, and becomes 0[V] in the period of a frame after the next, the value changes from 0 [V] to 5 [V] or 5[V] to 0 [V].

For example, inputting the vertical synchronization signal to a T flip-flop, which is not shown, allows the input signal V₁(t) to be generated.

For example, the input signal Vᵢ(t) shown in FIG. 7 is input to the waveform-signal generating circuit.

The input signal Vᵢ(t) input to the waveform-signal generating circuit is differentiated by the differentiating circuit, which is constituted by the capacitor 51 and the resistor 52. A resulting output signal Vₒ(t) is supplied by the differentiating circuit to the rectifying circuit at the next stage of the waveform-signal generating circuit.

FIG. 8 is a diagram showing an example of the output signal Vₒ(t). For example, the value of the output signal Vₒ(t) becomes −5 [V] at the start time of the period of one frame, and in the frame period, the value increases exponentially to substantially 0 [V] according to the elapse of time. The value of the output signal Vₒ(t) becomes 5 [V] at the start time of the period of a next frame, and in the frame period, the value decreases exponentially to substantially 0 [V] according to the elapse of time. The value of the output signal Vₒ(t) becomes −5 [V] at the start time of the period of a frame after the next, and in the frame period, the value increases exponentially to substantially 0 [V] according to the elapse of time.

In this manner, in each period of one frame, the value of the output signal Vₒ(t) changes exponentially from −5 [V] to substantially 0 [V] or from 5 [V] to substantially 0 [V] according to the elapse of time. The output signal Vₒ(t) is expressed by expression (1).

$$\begin{matrix}[ Expression 1 ] & \\ {V}_{0} ( t ) = E {e}^{- \frac{1}{{R}_{0} {C}_{0}} t} & ( 1 )\end{matrix}$$

In expression (1), C₀ indicates the capacitance value of the capacitor 51 and R₀ indicates the resistance value of the resistor 52. In expression (1), E indicates the amount of change of the input signal Vᵢ(t). For example, when the input signal Vᵢ(t) changes from 0 [V] to 5 [V], E is 5 [V], and when the input signal Vᵢ(t) changes from 5 [V] to 0 [V], E is −5 [V].

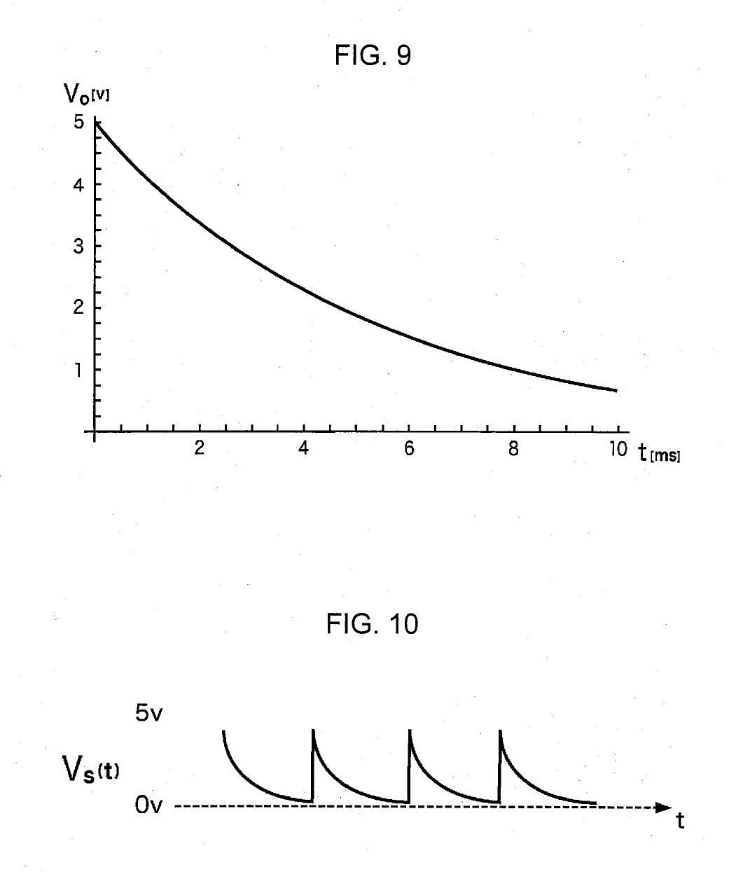

FIG. 9 is a graph illustrating a more detailed example of the output signal Vₒ(t) that reduces exponentially, according to the elapse of time, from 5 [V] at the start time of a frame, when the capacitance value C₀ of the capacitor 51 is 1 [μF] and the resistance value R₀ of the resistor 52 is 5 [kΩ].

The output signal Vₒ(t) shown in FIG. 9 becomes substantially 3.3 [V] at a point when 2 [ms] elapses from the start time of the frame and becomes substantially 2.2 [V] at a point when 4 [ms] elapses from the start time of the frame. The output signal Vₒ(t) shown in FIG. 9 becomes substantially 1.5 [V] at a point when 6 [ms] elapses from the start time of the frame and becomes substantially 1.0 [V] at a point when 8 [ms] elapses from the start time of the frame. The output signal Vₒ(t) shown in FIG. 9 becomes substantially 0.7 [V] at a point when 10 [ms] elapses from the start time of the frame.

The rectifying circuit in the waveform-signal generating circuit rectifies the output signal Vₒ(t). That is, as shown in FIG. 10, the rectifying circuit in the waveform-signal generating circuit inverts, of the output signal Vₒ(t), a signal having 0 [V] or less and outputs a rectification signal Vₛ(t), which is a signal having 0 [V] or more.

The rectifying circuit in the waveform-signal generating circuit shown in FIG. 6 is the so-called “full-wave rectifier” and is constituted by a resistor 53, an operational amplifier 54, a diode 55, a diode 56, a resistor 57, a resistor 58, a resistor 59, an operational amplifier 60, and a resistor 61.

The output signal Vₒ(t) is input to one end of the resistor 53 and one end of the resistor 59. The other end of the resistor 53 is connected to an inverse input terminal of the operational amplifier 54, the cathode (negative electrode) of the diode 55, and one end of the resistor 57. A non-inverting input terminal of the operational amplifier 54 is connected to ground.

An output terminal of the operational amplifier 54 is connected to the anode (positive electrode) of the diode 55 and the cathode of the diode 56. The other end of the resistor 57 is connected to the anode of the diode 56 and one end of the resistor 58.

The other end of the resistor 58 is connected to a non-inverting input terminal of the operational amplifier 60, the other end of the resistor 59, and one end of the resistor 61. A non-inverting input terminal of the operational amplifier 60 is connected to ground.

An output terminal of the operational amplifier 60 is connected to the other end of the resistor 61.

A voltage at the output terminal of the operational amplifier 60 is output as the rectification signal Vₛ(t).

Now, the operation of the rectifying circuit in the waveform-signal generating circuit will be briefly described. For example, when the output signal Vₒ(t) has a positive voltage, the operational amplifier 54 operates as an inverting amplifier having a gain of 1.

That is, when the output signal Vₒ(t) has a positive voltage, the operational amplifier 54 outputs a negative voltage whose absolute value is equal to a value obtained by adding a forward voltage of the diode 55 to the output signal Vₒ(t). In this case, due to a forward voltage of the diode 56, a negative voltage whose absolute value is equal to the output signal Vₒ(t) is applied to one end of the resistor 58.

When the output voltage Vₒ(t) has a negative voltage, a forward voltage is applied to the diode 55 and the output of the operational amplifier 54 becomes the forward voltage of the diode 55. In this case, due to the forward voltage of the diode 56, a voltage of 0 [V] is applied to one end of the resistor 58.

For example, the operational amplifier 60 operates as the so-called “adder” that inversely amplifies the voltage, applied to one end of the resistor 58, with a gain of 2 and that inversely amplifies the output signal Vₒ(t) with a gain of 1.

When a negative voltage whose absolute value is equal to the output signal Vₒ(t) is applied to one end of the resistor 58, the operational amplifier 60 inversely amplifies the voltage with a gain of 2 and inversely amplifies the output signal Vₒ(t) with a gain of 1. Thus, the operational amplifier 60 outputs a rectification signal Vₛ(t) equal to the output signal Vₒ(t). On the other hand, when a voltage of 0 [V] is applied to one end of the resistor 58, the operational amplifier 60 inversely amplifies the output signal Vₒ(t) with a gain of merely 1. Thus, the operational amplifier 60 outputs a rectification signal Vₛ(t) that is inversed from the output signal Vₒ(t).

Consequently, the forward voltage of the diode 55 and the forward voltage of the diode 56 cancel each other out, so that the rectifying circuit in the waveform-signal generating circuit outputs a rectification signal Vₛ(t) equal to the absolute value of the output signal Vₒ(t).

As shown in FIG. 10, for example, the value of the rectification signal Vₛ(t) becomes 5 [V] at the start time of the period of one frame, and in the frame period, the value decreases exponentially to substantially 0 [V] according to the elapse of time. The value of the output signal Vₒ(t) becomes 5 [V] at the start time of the period of a next frame, and in the frame period, the value decreases exponentially to substantially 0 [V] according to the elapse of time. The value of the output signal Vₒ(t) becomes 5 [V] at the start time of the period of a frame after the next, and in the frame period, the value decreases exponentially to substantially 0 [V] according to the elapse of time.

In this manner, in each period of one frame, the value of the rectification signal Vₛ(t) changes exponentially from 5 [V] to substantially 0 [V] according to the elapse of time.

As described above, the display controller 11 can have a simpler configuration.

As described by Block's Low (Block's Low) (Shikaku Jyoho Shori Handbook, edited by Nihon Shikaku Gakkai, Asakura-shoten, pp 217), human eyes sense brightness in proportion to the product of a light-emission intensity and time. Using the property, typical display apparatuses are configured to emit light in a light-emission period of time having a predetermined length, in order to secure brightness to be perceived viewers.

The present inventor observed a displayed moving image, while changing the length of the light-emission period. As a result, it was confirmed that a certain small ratio of the light-emission period to the period of a frame makes it difficult for moving-image blur to be perceived.

On the other hand, reducing the ratio of the light-emission period to the period of a frame permits jerkiness to be perceived in fixed vision.

It was confirmed in this case that, when light is emitted in a pulsed manner (i.e., in a rectangular-wave form), jerkiness is more strongly perceived, and when the brightness is gradually changed, for example, is exponentially attenuated according to time, jerkiness is less likely to be perceived.

A change in brightness according to time is not limited to a change in an exponential manner and it is confirmed that any time-sequential change, for example, a change in a linear manner with a predetermined inclination, can also provide the same advantages.

As described above, the apparatus is configured to perform display so that the brightness of the screen is time-sequentially increased or reduced in each period of a frame. Thus, an image that makes it difficult for motion blur and jerkiness to be perceived can be displayed at a lower frame rate.

The configuration of a display apparatus that displays an image based on image signals externally supplied will be described next.

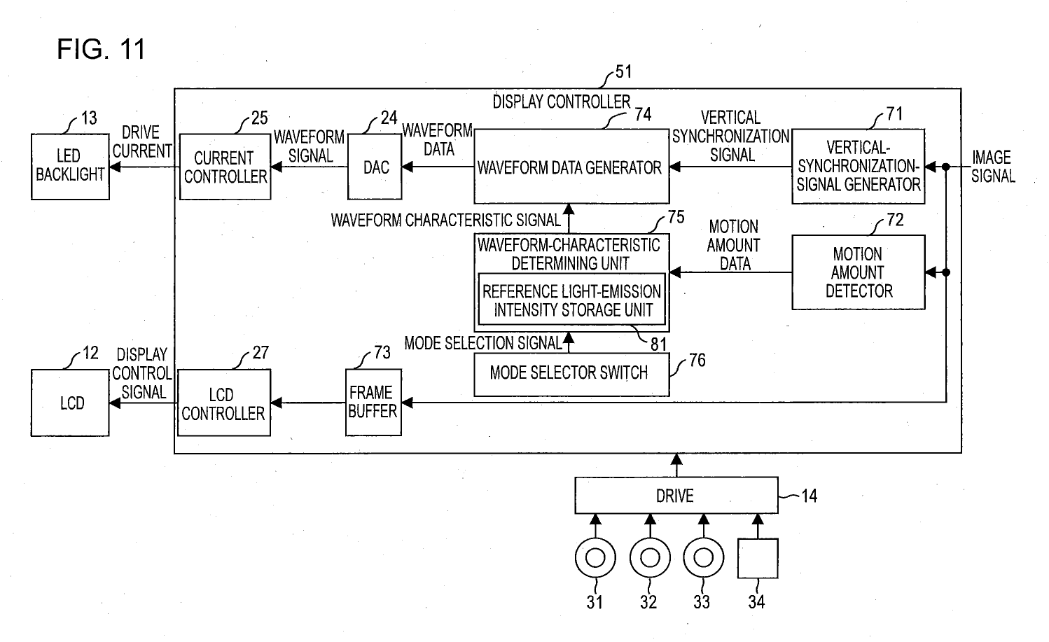

FIG. 11 is a block diagram showing another configuration of the embodiment of the display apparatus according to the present invention. Units similar to those in FIG. 1 are denoted with the same reference numerals and the descriptions thereof are omitted.

A display controller 51 controls the display of an LCD 12, which is one example of a display device, to display an image on the LCD 12 based on input image signals. The display controller 51 also controls the light emission of an LED backlight 13, which is one example of a light source for supplying light to the display device. The display controller 51 is realized with a dedicated circuit implemented with an ASIC, a programmable LSI such as an FPGA, or a general-purpose microprocessor for executing a control program.

The display controller 51 includes a DAC 24, a current controller 25, an LCD controller 27, a vertical-synchronization-signal generator 71, a motion-amount detector 72, a frame buffer 73, a waveform-data generator 74, a waveform-characteristic determining unit 75, and a mode selector switch 76.

Image signals input to the display controller 51 are supplied to the vertical-synchronization-signal generator 71, the motion-amount detector 72, and the frame buffer 73.

The vertical-synchronization-signal generator 71 generates a vertical signal synchronized with each frame of the supplied image signals and supplies the generated vertical synchronization signal to the waveform-data generator 74. The vertical-synchronization-signal generator 71 extracts a vertical synchronization signal from the image signals to generate a vertical signal or detects the period of each frame of the image signals to generate a vertical signal.

Based on the supplied image signals, the motion-amount detector 72 detects the amount of motion of an image object contained in a moving image to be displayed by the image signal. The motion-amount detector 72 supplies motion-amount data indicating the detected amount of motion of the image object to the waveform-characteristic determining unit 75. For example, using a block matching method, gradient method, phase correlation method, or pel-recursive method, the motion-amount detector 72 detects the amount of motion of an image object contained in a moving image to be displayed by the image signals.

The mode selector switch 76 is operated by the user and supplies, to the waveform-characteristic determining unit 75, a mode selection signal for giving an instruction for selecting a mode according to the user operation. For example, the mode selector switch 76 supplies, to the waveform-characteristic determining unit 75, a mode selection signal for giving an instruction for selecting a mode for maintaining the brightness of the LED backlight 13. Alternatively, the mode selector switch 76 supplies, to the waveform-characteristic determining unit 75, a mode selection signal for giving an instruction for selecting a mode for time-sequentially changing the brightness of the LED backlight 13 in accordance with the amount of motion of an image object contained in a moving image displayed by the image signals.

Based on the motion-amount data supplied from the motion-amount detector 72 and the mode selection signal supplied from the mode selector switch 76, the waveform-characteristic determining unit 75 generates waveform characteristic data describing characteristics of waveform data generated by the waveform data generator 74.

For example, when the mode selection signal for giving an instruction for selecting a mode for maintaining the brightness of the LED backlight 13 is supplied, the waveform-characteristic determining unit 75 generates waveform characteristic data describing characteristics of maintained waveform data. More specifically, the waveform-characteristic determining unit 75 determines a function (e.g., ƒ(t)=a) that does not include time and generates waveform characteristic data that includes a value (a=5) that determines the function.

For example, when the mode selection signal for giving an instruction for selecting a mode for time-sequentially changing the brightness of the LED backlight 13 in accordance with the amount of motion of an image object contained in a moving image displayed by the image signals, the waveform-characteristic determining unit 75 generates waveform characteristic data describing characteristics of waveform data for time-sequentially changing the brightness of the LED backlight 13 in the period of a frame, based on the amount of motion indicated by the motion-amount data supplied from the motion-amount detector 72.

More specifically, the waveform-characteristic determining unit 75 generates waveform characteristic data (identifying waveform data) describing characteristics of waveform data so that the product value of the brightness of the LED backlight in the period of the frame is equal to a reference light-emission intensity stored in the reference light-emission-intensity storage unit 81.

As indicated by Block's Law described above, human eyes sense brightness in proportion to the product of a light-emission intensity and time. The reference light-emission intensity is data indicating brightness sensed by human eyes and is expressed in units of the product of a light-emission intensity and time.

Herein, the characteristics of the waveform data refers to waveform data characteristics, such as the maximum value of brightness, the rate of a brightness change to time, and how the brightness changes relative to time (e.g., a change in an exponential manner or a change in a linear manner).

For example, when the amount of motion indicated by the motion-amount data supplied from the motion-amount detector 72 is large, the waveform-characteristic determining unit 75 generates waveform characteristic data describing characteristics of waveform data for causing the LED backlight 13 to emit light so that the maximum value of the brightness is increased, the light-emission period is reduced, and the value of the product of brightness and time in a frame period becomes equal to the reference light-emission intensity stored in the reference light-emission-intensity storage unit 81.

When the amount of motion indicated by the motion-amount data supplied from the motion-amount detector 72 is small, the waveform-characteristic determining unit 75 generates waveform characteristic data describing characteristics of waveform data for causing the LED backlight 13 to emit light so that the maximum value of the brightness is reduced, the light-emission period is extended, and the value of the product of brightness and time in a frame period becomes equal to the reference light-emission intensity stored in the reference light-emission-intensity storage unit 81.

More specifically, for example, the waveform-characteristic determining unit 75 generates waveform characteristic data that specifies a function including time indicated by expression (1) and that includes values for identifying the function. Examples of the values include E, R₀, and C₀ in expression (1). When the amount of motion indicated by the motion-amount data supplied from the motion-amount detector 72 is large, E is set to be a larger value and a time constant defined by R₀ and C₀ is set to a smaller value. When the amount of motion indicated by the motion-amount data supplied from the motion-amount detector 72 is smaller, E is set to be a smaller value and a time constant defined by R₀ and C₀ is set to a larger value.

The waveform-characteristic determining unit 75 supplies the waveform characteristic data, generated as described above and describing the characteristics of the waveform data, to the waveform-data generator 74.

In synchronization with the vertical synchronization signal supplied from the vertical-synchronization-signal generator 71, the waveform-data generator 74 generates waveform data described by the waveform-characteristic data supplied from the waveform-characteristic determining unit 75.

For example, when the waveform characteristic data is supplied from the waveform-characteristic determining unit 75, the waveform-data generator 74 pre-computes a waveform data value corresponding to the elapse of time and stores the determined waveform data value. When the vertical synchronization signal is supplied from the vertical-synchronization-signal generator 71, the waveform-data generator 74 reads the stored waveform-data value and sequentially outputs the read waveform-data value to thereby generate waveform data in accordance with time elapsed from the start time of a frame.

With this arrangement, even when the computing power is small, waveform data can be generated.

For example, based on the waveform-characteristic data supplied from the waveform-characteristic determining unit 75 and the vertical synchronization signal supplied from the vertical-synchronization-signal generator 71, the waveform-data generator 74 computes, in real time, the value of stored waveform data according to time elapsed from the start time of a frame and outputs the computed waveform-data value to thereby generate waveform data.

With this arrangement, when the waveform characteristic data supplied from the waveform-characteristic determining unit 75 changes, waveform data described by the changed waveform characteristic data can be output immediately.

As described above, based on the vertical synchronization signal, the waveform-data generator 74 generates waveform data for time-sequentially changing the brightness of the LED backlight 13, in synchronization with each frame.

The waveform-data generator 74 supplies the generated waveform data to the DAC 24.

The frame buffer 73 temporarily stores image signals and supplies the stored image signals to the LCD controller 27. The frame buffer 73 delays the image signals by the amount of time required for the processing performed by the vertical-synchronization-signal generator 71 to the waveform-data generator 74 and supplies the delayed image signals to the LCD controller 27.

With this arrangement, the brightness of the LED backlight 13 can be time-sequentially changed in reliable synchronization with a frame of an image displayed by the LCD 12.

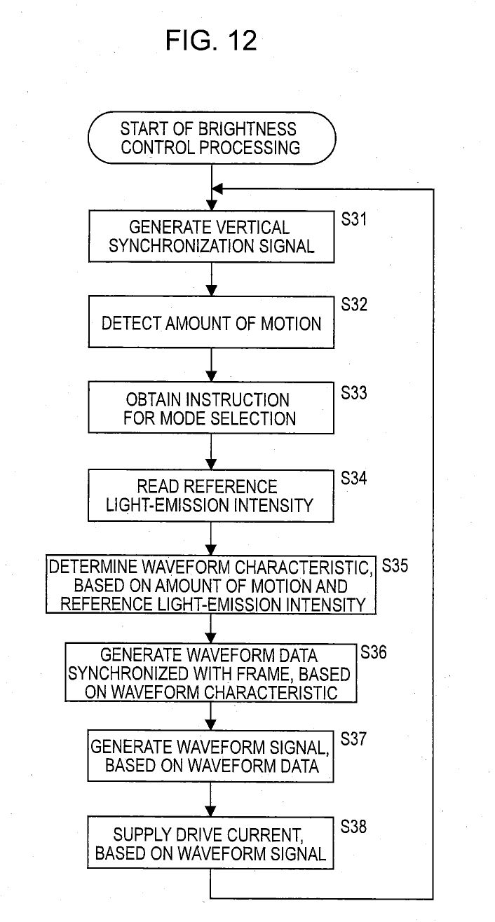

Next, another processing for brightness control performed by the display controller 11 shown in FIG. 11 and for executing a control program will be described with reference to the flow chart shown in FIG. 12.

In step S31, the vertical-synchronization-signal generator 71 generates a vertical synchronization signal for synchronization with each frame of a moving image to be displayed by input image signals. For example, image signals for displaying a moving image of 24 to 500 frames per second can be input.

In step S32, based on the supplied image signals, the motion-amount detector 72 uses block matching or a gradient method to detect the amount of motion of an image object contained in a moving image to be displayed by the image signal.

In step S33, the waveform-characteristic determining unit 75 obtains a mode selection signal, supplied from the mode selector switch 76, for giving an instruction for selecting a mode according to a user operation.

In step S34, the waveform-characteristic determining unit 75 reads a reference light-emission intensity stored in a reference light-emission-intensity storage unit 81. The reference light-emission intensity is data that is stored in the reference light-emission-intensity storage unit 81 and that indicates the brightness sensed by human eyes, and is expressed in units of the product of a light-emission intensity and time.

For example, the reference light-emission intensity may have a predetermined value or may be set in accordance with a user operation.

In step S35, the waveform-characteristic determining unit 75 determines waveform characteristics, based on the amount of motion and the reference light-emission intensity. For example, in step S35, based on the amount of motion and the reference light-emission intensity, the waveform-characteristic determining unit 75 determines waveform characteristics, including the maximum value of brightness, the ratio of a brightness change to time, or a how the brightness changes relative to time, such as a change in linear form or a curve form expressed by an exponential function.

For example, in step S35, when the amount of motion is larger, the waveform-characteristic determining unit 75 generates waveform characteristic data describing characteristics of waveform data for causing the LED backlight 13 to emit light so that the maximum value of the brightness is increased, the light-emission period is reduced, and the value of the product of brightness and time in a frame period becomes equal to the reference light-emission intensity stored in the reference light-emission-intensity storage unit 81.

More specifically, for example, in step S35, when the amount of motion is larger, the waveform-characteristic determining unit 75 generates waveform characteristic data describing characteristics of waveform data so that the maximum value of the waveform data is increased to cause the waveform data to change more rapidly according to time and the value of the product of waveform data based on time becomes equal to the reference light-emission intensity stored in the reference light-emission-intensity storage unit 81.

When the waveform characteristic data describing characteristics of waveform data is generated so that the value of the product of waveform data based on time becomes equal to the reference light-emission intensity, the reference light-emission intensity is expressed in units of the product of time and a voltage value corresponding to the light-emission intensity.

When the amount of motion is larger, reducing the light-emission period can make it more difficult for motion blur to be sensed.

Conversely, when the amount of motion is smaller, the waveform-characteristic determining unit 75 generates waveform characteristic data describing characteristics of waveform data for causing the LED backlight 13 to emit light so that the maximum value of the brightness is reduced, the light-emission period is extended, and the value of the product of brightness and time in a frame period becomes equal to the reference light-emission intensity stored in the reference light-emission-intensity storage unit 81.

More specifically, for example, in step S35, when the amount of motion is smaller, the waveform-characteristic determining unit 75 generates waveform characteristic data describing characteristics of waveform data so that the maximum value of the waveform data is reduced to cause the waveform data to change more gently according to time and the value of the product of waveform data based on time becomes equal to the reference light-emission intensity stored in the reference light-emission-intensity storage unit 81.

When the amount of motion is smaller, extending the light-emission period can make it more difficult for jerkiness to be sensed.

In step S36, based on the vertical synchronization signal and the waveform characteristics, the waveform data generator 36 generates waveform data synchronized with a frame. In step S37, the DAC 24 performs digital-to-analog conversion on the waveform data, and based on the generated waveform data, the DAC 24 generates a waveform signal corresponding to the waveform data.

In step S38, based on the generated waveform signal, the current controller 25 supplies drive current to the LED backlight 13. The process then returns to step S31 and the processing described above is repeated. With this configuration, the LED backlight 13 can emit light so as to time-sequentially reduce the brightness or time-sequentially increase the brightness in synchronization with a frame in each period in which one frame is displayed.

The brightness of the LED backlight 13 is time-sequentially reduced or time-sequentially increased in each period of a frame such that, when a larger amount of motion is detected as a result of image motion detection, the light-emission period is reduced, and when a smaller amount of motion is detected, the light-emission period is extended. Thus, even when the amount of motion of an image object increases or decreases, an image that makes it difficult for motion blur and jerkiness to be perceived can be displayed.

When frequency components of an image are extracted from input signals by FFT (Fast Fourier Transform) or the like and the image contains a larger amount of high frequency components, the light-emission period may be further reduced.

The LED backlight 13 may be driven by a PWM (pulse width modulation) system.

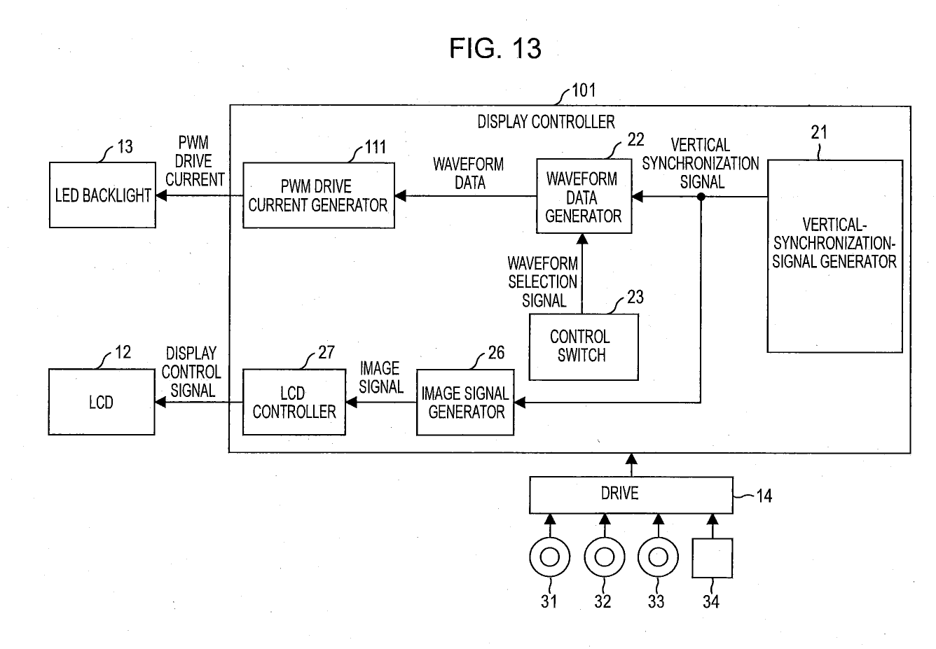

FIG. 13 is a block diagram showing yet another configuration of the embodiment of the display apparatus according to the present invention, the light source being driven by a PWM system in the configuration. Units similar to those in FIG. 1 are denoted with the same reference numerals and the descriptions thereof are omitted.

A display controller 101 controls the display of an LCD 12, which is one example of a display device, and controls the light emission of a LED backlight 13, which is one example of a light source, by a PWM system. The display controller 101 is realized with a dedicated circuit implemented with an ASIC, a programmable LSI such as an FPGA, or a general-purpose microprocessor for executing a control program.

The display controller 101 includes a vertical-synchronization-signal generator 21, a waveform data generator 22, a control switch 23, an image-signal generator 26, an LCD controller 27, and a PWM drive-current generator 111.

Based on waveform data supplied from the waveform-data generator 22, the PWM drive-current generator 111 supplies, to the LED backlight 13, PWM-system-based PWM drive current for controlling the brightness of the LED backlight by using a pulse width, to thereby drive the LED backlight 13.

The use of a PWM system can reduce the loss of power in the display controller 101.

Instead of the PWM system, another digital drive system, such as a PAM (pulse amplitude modulation) system may be used to drive the LED backlight 13.

When rectangular-wave-containing drive current based on a PWM system, PAM system, or the like is used to change the brightness of the LED backlight 13, it is preferable that the LED backlight 13 be driven with a higher-frequency rectangular wave that makes it impossible for people to perceive a change according to the rectangular wave.

In addition, controlling the brightness of a light source for each of the three primary colors makes it possible to prevent the color of an image to be displayed from varying, even when the brightness is reduced or increased.

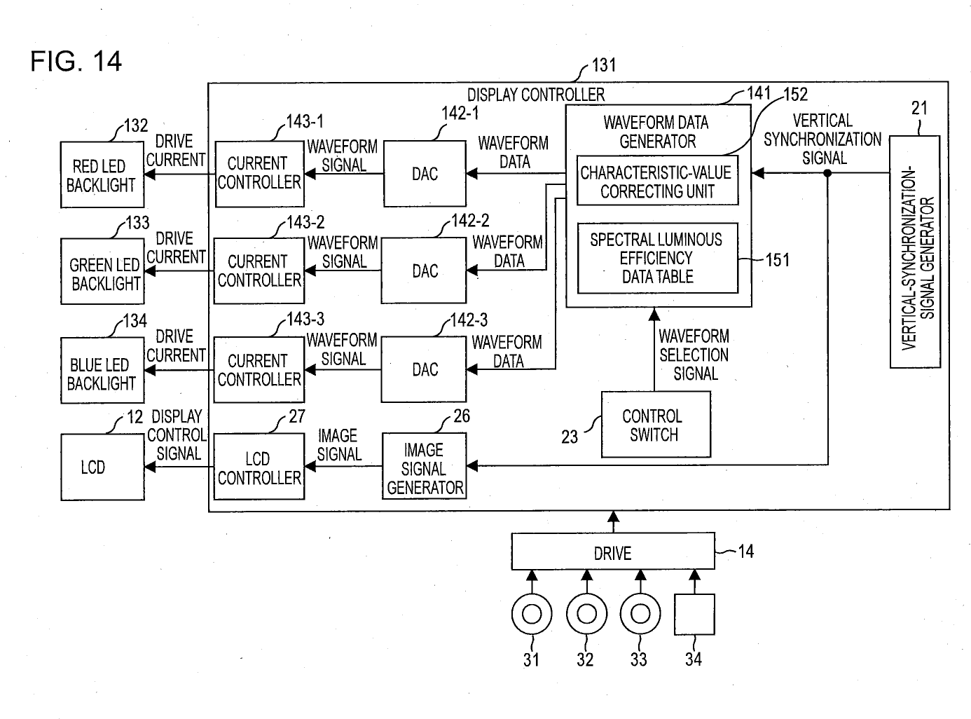

FIG. 14 is a block diagram showing yet another configuration of the embodiment of the display apparatus according to the present invention, the brightness of a backlight being controlled for each of the three primary colors of light in the configuration. Units similar to those in FIG. 1 are denoted with the same reference numerals and the descriptions thereof are omitted.

The display controller 131 controls the display of an LCD 12 and also controls the light emission of a red LED backlight 132, which is one example of a light source for supplying light to a display device, a green LED backlight 133, and a blue LED backlight 134. The display controller 131 is realized with a dedicated circuit implemented with an ASIC, a programmable LSI such as an FPGA, or a general-purpose microprocessor for executing a control program.

The red LED backlight 132 includes one or multiple red LEDs. Under the control of the display controller 131, the red LED backlight 132 emits red light (emits light in red), which is one of the three primary colors of light. The green LED backlight 133 includes one or multiple green LEDs. Under the control of the display controller 131, the green LED backlight 133 emits green light (emits light in green), which is another one of the three primary colors of light. The blue LED backlight 134 includes one or multiple blue LEDs. Under the control of the display controller 131, the blue LED backlight 134 emits blue light (emits light in blue), which is the other one of the three primary colors of light.

The display controller 131 includes a vertical-synchronization-signal generator 21, a control switch 23, an image signal generator 26, an LCD controller 27, a waveform data generator 141, DACs 142-1 to 142-3, and current controllers 143-1 to 143-3.

Based on a waveform selection signal that is supplied from the control switch 23 and that gives an instruction for selecting a waveform, the waveform data generator 141 generates waveform data for specifying the brightness of the red LED backlight 132, waveform data for specifying the brightness of the green LED backlight 133, and waveform data for specifying the brightness of the blue LED backlight 134, in synchronization with a vertical synchronization signal. For example, the waveform-data generator 141 generates waveform data for time-sequentially changing the brightness of each of the red LED backlights 132 to the blue LED backlight 134.

The waveform data generator 141 includes a spectral-luminous-efficiency data table 151 and a characteristic-value correcting unit 152. The spectral-luminous-efficiency data table 151 stores spectral-luminous-efficiency data indicating the sensitivity of human eyes and corresponding to the intensity of light (including the three primary colors) having each wavelength.

The sensitivity of human eyes changes according to a light wavelength depending on brightness. In other words, when the brightness varies, the sensitivity of human eyes changes for each light wavelength.

Thus, when the brightness of a light source is uniformly reduced or increased relative to a light wavelength, the white balance varies. That is, even for the same image, color (color sensed by a person viewing the image) varies.

The spectral-luminous-efficiency data is data indicating human eye sensitivity for each light wavelength and brightness (K. Sagawa and K. Takeichi: Mesopic spectral luminous efficiency functions: Final experimental report, Journal of Light and Visual Environment, 11, 22-29, 1987).

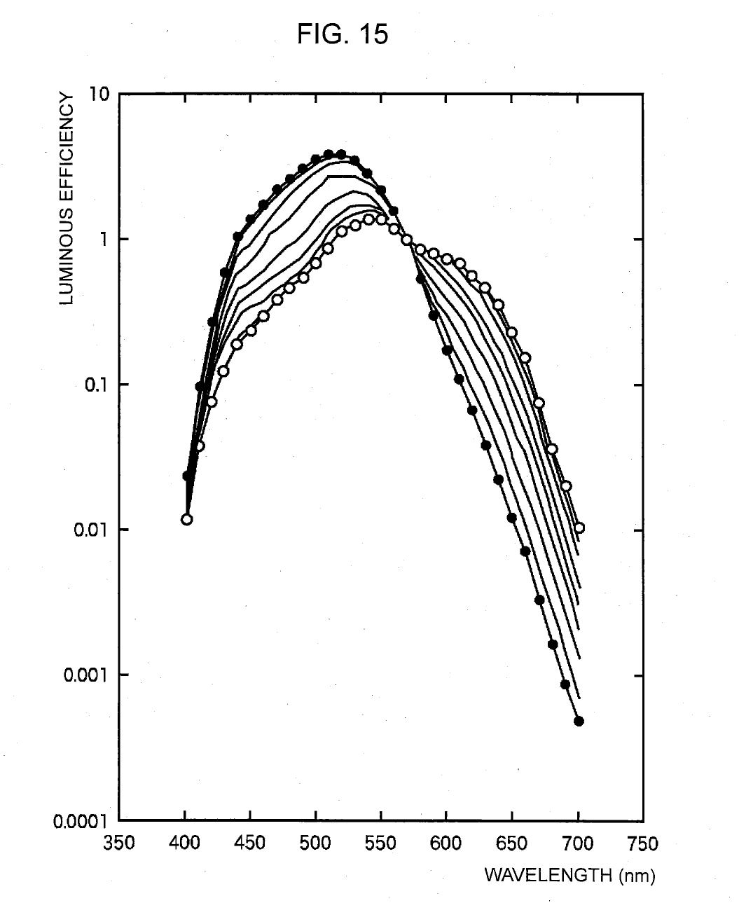

FIG. 15 is a graph showing an example of the spectral-luminous-efficiency data. The spectral-luminous-efficiency data shown in FIG. 15 indicates luminous efficiencies of wavelengths for nine levels from a photopic vision (100 [td]) to a scotopic vision (0.01 [td]) with reference to a wavelength of 570 [nm]. In FIG. 15, black dots indicate luminous efficiency in a photopic vision and white dots indicate luminous efficiency in a scotopic vision.

As the retinal illumination level decreases, the luminous efficiency for a short-wavelength region tends to increase relatively and, conversely, the luminous efficiency for a long-wavelength region tends to decrease gradually.

Based on the spectral-luminous-efficiency data stored in the spectral-luminous-efficiency data table 151, the characteristic-value correcting unit 152 corrects a characteristic value defining (a characteristic of) waveform data specifying the brightness of red of the three primary colors, a characteristic value defining (a characteristic of) waveform data specifying the brightness of green, and a characteristic value defining (a characteristic of) waveform data specifying the brightness of blue so that the white balance becomes constant according to a change in the brightness.

In this case, the characteristic values defining the characteristics of waveform data specifying the respective brightnesses of the three primary colors are internal data of the waveform-data generator 141 and can be provided by the same system as one for the above-described waveform-characteristic data.

As described above, human eyes have a tendency that, as the brightness decreases, the luminous efficiency for blue and its vicinity increases relatively and the luminous efficiency for red and its vicinity decreases relatively. Thus, for example, when the brightness is reduced, the characteristic-value correcting unit 152 corrects the characteristic value defining waveform data specifying the brightness of red so as to relatively increase the brightness of red and corrects the characteristic value defining waveform data specifying the brightness of blue so as to relatively reduce the brightness of blue. Conversely, when the brightness is increased, the characteristic-value correcting unit 152 corrects the characteristic value defining waveform data specifying the brightness of red so as to relatively reduce the brightness of red and corrects the characteristic value defining waveform data specifying the brightness of blue so as to relatively increase the brightness of blue.

That is, based on the spectral luminous efficiency of human eyes, the characteristic-value correcting unit 152 corrects the characteristic values defining the characteristics of waveform data specifying the respective brightnesses of the three primary colors of light. In other words, based on the spectral luminous efficiency of human eyes, the characteristic-value correcting unit 152 corrects a characteristic value for each of the three primary colors of light, the characteristic value defining a characteristic for time-sequentially increasing or time-sequentially reducing the brightness of the screen, so as to cancel out a change in human eye sensitivity (relative sensitivity) according to a brightness change and relative to each of the three primary colors of light.

This arrangement can prevent the white balance from varying, even when the brightness is changed. That is, even when the brightness is changed, the same image can be seen in the same color. In other words, even when the brightness is changed, the color sensed by people viewing the same image can be the same.

In accordance with the characteristic values corrected based on the spectral-luminous-efficiency data as described above, the waveform data generator 141 generates waveform data for specifying the brightness of the red LED backlight 132, waveform data for specifying the brightness of the green LED backlight 133, and waveform data for specifying the brightness of the blue LED backlight 134.

The waveform-data generator 141 supplies the waveform data for specifying the brightness of the red LED backlight 132 to the DAC 142-1. The waveform-data generator 141 supplies the waveform data for specifying the brightness of the green LED backlight 133 to the DAC 142-2. The waveform-data generator 141 supplies the waveform data for specifying the brightness of the blue LED backlight 134 to the DAC 142-3.

The DAC 142-1 performs digital-to-analog conversion on the waveform data, which is digital data, for specifying the brightness of the red LED backlight 132, the waveform data being supplied from the waveform-data generator 141. That is, the DAC 142-1 performs digital-to-analog conversion on the waveform data, which is digital data, and supplies the resulting waveform signal, which is a voltage analog signal, to the current controller 143-1. The voltage value of the waveform signal output from the DAC 142-1 corresponds to the value of the waveform data input to the DAC 142-1.

The DAC 142-2 performs digital-to-analog conversion on the waveform data, which is digital data, for specifying the brightness of the green LED backlight 133, the waveform data being supplied from the waveform-data generator 141. That is, the DAC 142-2 performs digital-to-analog conversion on the waveform data, which is digital data, and supplies the resulting waveform signal, which is a voltage analog signal, to the current controller 143-2. The voltage value of the waveform signal output from the DAC 142-2 corresponds to the value of the waveform data input to the DAC 142-2.

The DAC 142-3 performs digital-to-analog conversion on the waveform data, which is digital data, for specifying the brightness of the blue LED backlight 134, the waveform data being supplied from the waveform-data generator 141. That is, the DAC 142-3 performs digital-to-analog conversion on the waveform data, which is digital data, and supplies the resulting waveform signal, which is a voltage analog signal, to the current controller 143-2. The voltage value of the waveform signal output from the DAC 142-3 corresponds to the value of the waveform data input to the DAC 142-3.

The current controller 143-1 converts the waveform signal, which was supplied from the DAC 142-1 and is a voltage analog signal for specifying the brightness of the red LED backlight 132, into drive current and supplies the converted drive current to the red LED backlight 132. The current controller 143-2 converts the waveform signal, which was supplied from the DAC 142-2 and is a voltage analog signal for specifying the brightness of the green LED backlight 133, into drive current and supplies the converted drive current to the green LED backlight 133. The current controller 143-3 converts the waveform signal, which was supplied from the DAC 142-3 and is a voltage analog signal for specifying the brightness of the blue LED backlight 134, into drive current and supplies the converted drive current to the blue LED backlight 134.

As described above, an image that makes it difficult for motion blur and jerkiness to be perceived can be displayed at a lower frame rate. Further, even when the brightness is changed, an image can be displayed so that the image is seen in the same color without a change in the white balance.

Next, a description is given of a case using a light source that cannot change the brightness in a shorter period of time than the period of a frame.

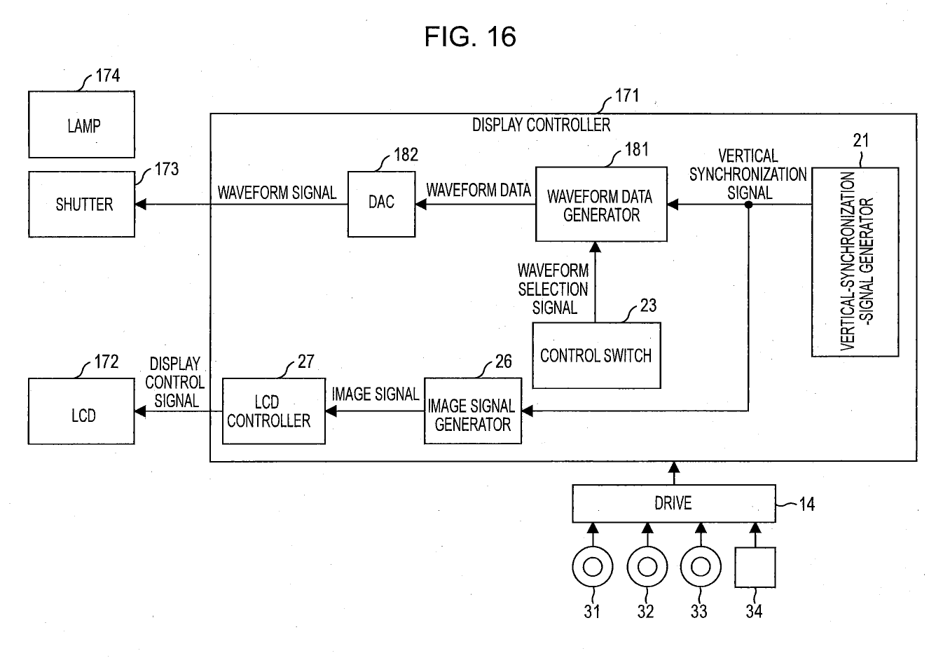

FIG. 16 is a block diagram showing yet another configuration of the embodiment of the display apparatus according to the present invention, a light source that cannot change the brightness in a shorter period of time than the period of a frame being used in the configuration. Units similar to those in FIG. 1 are denoted with the same reference numerals and the descriptions thereof are omitted.

A display controller 171 controls the display of an LCD 172, which is one example of a display device. The display controller 171 also controls a shutter 173, which adjusts the amount of light emitted from a lamp 174, which is one example of a light source for supplying light to the display device, and incident on the LCD 172. The display controller 171 is realized with a dedicated circuit implemented with an ASIC, a programmable LSI such as an FPGA, or a general-purpose microprocessor for executing a control program.

The LCD 172 includes, for example, a reflective liquid crystal panel or transmissive liquid crystal panel and displays an image on a screen, which is not shown, under the control of the display controller 11. The shutter 173 is implemented with, for example, a liquid-crystal shutter that can adjust the amount of light at a high speed relative to the period of a frame. Under the control of the display controller 171, the shutter 173 adjusts the amount of light emitted from the lamp 174 and incident on the LCD 172.

The lamp 174 is a light source that cannot change the brightness in a shorter period of time than the period of a frame and is, for example, a xenon lamp, a metal halide lamp, or a super-high pressure mercury lamp.

The display controller 171 includes a vertical-synchronization-signal generator 21, a control switch 23, an image-signal generator 26, an LCD controller 27, a waveform-data generator 181, and a DAC 182.

Based on a wave-form selection signal that is supplied from the controller switch 23 and that gives an instruction for selecting a waveform, the waveform-data generator 181 generates waveform data specifying the amount of light emitted from the lamp 174 and incident on the LCD 172, in synchronization with a vertical synchronization signal supplied from the vertical-synchronization-signal generator 21. For example, the waveform-data generator 181 generates waveform data for time-sequentially increasing or reducing the amount of light incident on the LCD 172.

The DAC 182 performs digital-to-analog conversion on the waveform data, which is digital data, supplied from the waveform-data generator 181. That is, the DAC 182 performs digital-to-analog conversion on the waveform data, which is digital data, and supplies the resulting waveform signal, which is a voltage analog signal, to the shutter 173. The voltage value of the waveform signal output from the DAC 182 corresponds to the value of the waveform data input to the DAC 182.

Based on the waveform signal supplied from the DAC 182, the shutter 173 adjusts the amount of light emitted from the lamp 174 and incident on the LCD 172. For example, the shutter 173 adjusts the amount of light emitted from the lamp 174 and incident on the LCD 172 so that the amount of light decreases or increases time-sequentially.

For example, the shutter 173 adjusts the amount of light emitted from the lamp 174 and incident on the LCD 172 so that, when a waveform signal having a larger value is supplied, a larger amount of light from the lamp 174 is incident on the LCD 172, and when a waveform signal having a smaller value is supplied, a larger amount of light from the lamp 174 is incident on the LCD 172.

With this arrangement, even when a light source that cannot change the brightness at a high speed relative to the period of a frame is used, the brightness of a screen can be time-sequentially increased or time-sequentially reduced in the period of the frame. Thus, it is possible to display an image that has a smaller amount of motion blur and that prevents jerkiness from being perceived.

Although the shutter 173 has been described as being provided between the lamp 174 and the LCD 172 to adjust the amount of light incident on the LCD 172, the lamp 174, the LCD 172, and the shutter 173 may be provided in that order (be provided adjacent to the screen of the LCD 172) so as to adjust the amount of light emitted from the LCD 172.

Next, a description is given of a case in which the display device is implemented with an LED display.

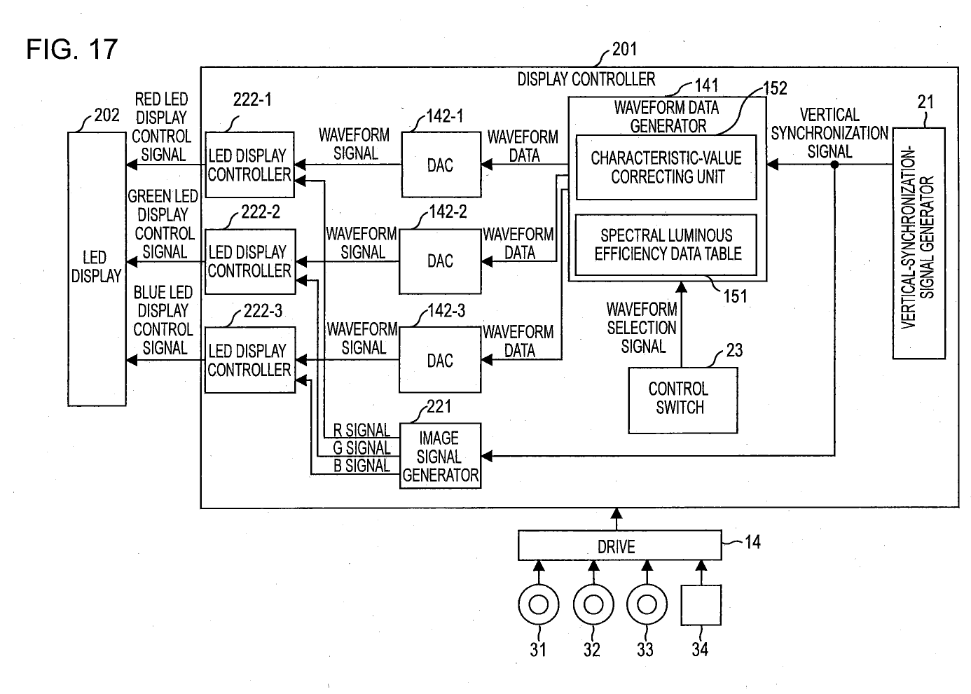

FIG. 17 is a block diagram showing still another configuration of the embodiment of the display apparatus according to the present invention, the display device being implemented with an LED display in the configuration. Units similar to those in FIG. 14 are denoted with the same reference numerals and the descriptions thereof are omitted.

A display controller 201 controls the display of an LED display 202, which is one example of the display device. The display controller 201 is realized with a dedicated circuit implemented with an ASIC, a programmable LSI such as an FPGA, or a general-purpose microprocessor for executing a control program.

The LED display 202 includes red LEDs for emitting red light (i.e., for emitting light in red), which is one of the three primary colors of light, green LEDS for emitting green light (i.e., for emitting light in green), which is another one of the three primary colors of light, and blue LEDs for emitting blue light (i.e., for emitting light in blue), which is the other one of the three primary colors of light. In the LED display 202, the red LEDs, the green LEDs, and the blue LEDs are arranged so that the red LEDs, the green LEDs, and the blue LEDs serve as sub-pixels.

Based on a red LED display control signal, a green LED display control signal, and a blue LED display control signal supplied from the display controller 201, the LED display 202 causes the arranged red LEDs, the green LEDs, and the blue LEDs to emit light, respectively.

The display controller 201 includes a vertical-synchronization-signal generator 21, a control switch 23, a waveform data generator 141, DACs 142-1 to 142-3, an image-signal generator 221, and LED display controllers 222-1 to 222-3.

The image-signal generator 221 generates image signals for displaying a predetermined image, in synchronization with a vertical synchronization signal, supplied from the vertical-synchronization-signal generator 21, for synchronization with each frame of a moving image to be displayed. The image signals generated by the image signal generator 221 is constituted by an R signal indicating the intensity of red light of the three primary colors (i.e., the intensity of light-emission of the red sub-pixels), a G signal indicating the intensity of green light of the three primary colors (i.e., the intensity of light-emission of the green sub-pixels), a B signal indicating the intensity of blue light of the three primary colors (i.e., the intensity of light-emission of the blue sub-pixels) for an image to be displayed.

The image signal generator 221 supplies the R signal to the LED display controller 222-1, supplies the G signal to the LED display controller 222-2, and supplies the B signal to the LED display controller 222-3.

Based on the R signal that is supplied from the image signal generator 221 and the waveform signal that is supplied from the DAC 142-1 and that specifies the brightness of red light of the three primary colors so as to time-sequentially increase or reduce the brightness in synchronization with a frame in the period of the frame, the LED display controller 222-1 generates a red LED display control signal for causing the red LEDs, arranged in the LED display 202, to emit light so that the brightness increases or decreases time-sequentially in the period of the frame. The LED display controller 222-1 supplies the generated red LED display control signal to the LED display 202.

Based on the G signal that is supplied from the image signal generator 221 and the waveform signal that is supplied from the DAC 142-2 and that specifies the brightness of green light of the three primary colors so as to time-sequentially increase or reduce the brightness in synchronization with a frame in the period of the frame, the LED display controller 222-2 generates a green LED display control signal for causing the green LEDs, arranged in the LED display 202, to emit light so that the brightness increases or decreases time-sequentially in the period of the frame. The LED display controller 222-2 supplies the generated green LED display control signal to the LED display 202.

Based on the B signal that is supplied from the image signal generator 221 and the waveform signal that is supplied from the DAC 142-3 and that specifies the brightness of blue light of the three primary colors so as to time-sequentially increase or reduce the brightness in synchronization with a frame in the period of the frame, the LED display controller 222-3 generates a blue LED display control signal for causing the blue LEDs, arranged in the LED display 202, to emit light so that the brightness increases or decreases time-sequentially in the period of the frame. The LED display controller 222-3 supplies the generated blue LED display control signal to the LED display 202.

Based on the red LED display control signal, the green LED display control signal and the blue LED display control signal supplied from the corresponding LED display controller 222-1 to the LED display controller 222-3, the LED display 202 causes the red LEDs, the green LEDs, and the blue LEDs to emit light, respectively, so that the brightness increases or decreases time-sequentially in the period of the frame.

As described above, it is also possible for a self-light-emitting display apparatus to display an image that makes it difficult for motion blur and jerkiness to be perceived at a lower frame rate.

The present invention is also applicable to, for example, a reflective-projection-type display apparatus or transmissive-projection-type display apparatus, such as a front projector or rear projector using reflective liquid crystal or transmissive liquid crystal, a transmissive direct-viewing-type display apparatus typified by a direct-viewing liquid crystal display, or a self-light-emitting display apparatus in which light emitting devices such as LEDs or EL (electro luminescent) devices are arranged in a array. Such an arrangement can also provided the same advantages as described above.

The present invention is not limited to a display apparatus that displays a moving image based on the so-called “progressive system” and is similarly applicable to a display apparatus that displays a moving image based on the so-called “interlace system”.

The display apparatus includes an apparatus that has a display function and another function. Examples include the so-called “notebook personal computer, a PDA (personal digital assistant), a mobile phone, and a digital camera.

When the light source is designed to emit light at a predetermined brightness in the period of a frame, an image can be displayed. With the arrangement for time-sequentially increasing or reducing the brightness of the screen in each period of a frame, the so-called “hold-type display apparatus” in which display is held during the period of each frame can display an image that makes it difficult motion blur and jerkiness to be perceived at a lower frame rate.

The above described series of processing can be executed by hardware and can also be executed by software. When the series of processing is executed by software, a program for implementing the software is installed from a storage medium onto a computer incorporated into dedicated hardware or onto, for example, a general-purpose personal computer that can execute various functions through installation of various programs.

The storage medium may be a package medium that stores a program and that is distributed separately from a computer to provide users with the program. As shown in FIG. 1, 11, 13, 14, 16, or 17, an example of the package medium is the magnetic disk 31 (including a flexible disk), the optical disk 32 (including a CD-ROM (compact disk-read only memory) or a DVD (digital versatile disk)), the magneto-optical disk 33 (including an MD (mini-disk) (trademark)), or the semiconductor memory 34. The storage medium may also be a ROM in which the program is stored or a hard disk, the ROM and the hard disk being supplied to users in a state in which they are pre-installed in a computer.

The program for causing the execution of the above-described processing may be installed on a computer thorough a wired or wireless communication medium, such as a local area network, the Internet, digital satellite broadcast via an interface, such as a rooter or a modem, as needed.

Herein, the steps for describing the program stored in the storage medium not only include processing that is time-sequentially performed according to the described sequence but also include processing that is concurrently or individually executed without being necessarily time-sequentially performed.

1. A display apparatus comprising:
a backlight configured to time-sequentially increase or time-sequentially decrease a brightness of a light emission during a frame of an image, said light emission being emissible from said backlight;
a panel of pixels configured to display said image, said light emission from the backlight being emissible through said panel;
a display controller configured to convert digital waveform data into an analog sequence signal, an increase or decrease of the brightness during the frame being controllable by a waveform of the sequence signal.

2. The display apparatus according to claim 1, wherein said backlight includes a light emitting diode, said light emitting diode being configured to emit said light emission.

3. The display apparatus according to claim 1, wherein said brightness is decreasable from a start of the frame.

4. The display apparatus according to claim 1, wherein said brightness is exponentially decreasable from a start of the frame to an end of the frame.

5. The display apparatus according to claim 1, wherein said brightness is linearly decreasable from a start of the frame to an end of the frame.

6. The display apparatus according to claim 1, wherein said brightness remains constant from a start of the frame to an elapsed time during the frame, said brightness being decreasable from said elapsed time to an end of the frame.

7. The display apparatus according to claim 1, wherein said brightness is increasable from a start of the frame.

8. The display apparatus according to claim 1, wherein said panel is a liquid crystal panel.

9. The display apparatus according to claim 1, wherein said panel is configured to receive an image signal from said display controller, said image corresponding to said image signal.

10. The display apparatus according to claim 1, wherein said waveform of the sequence signal is a variable voltage.

11. The display apparatus according to claim 1, wherein said waveform of the sequence signal is user-selectable.

12. The display apparatus according to claim 1, wherein said display controller is configured to generate a display control signal in synchronization with said sequence signal, said pixels being controllable by said display control signal.

13. The display apparatus according to claim 1, wherein said waveform data determines said waveform of the sequence signal.

14. The display apparatus according to claim 1, wherein said waveform data specifies an amount of the brightness.

15. The display apparatus according to claim 1, wherein said the sequence signal is a pulse width amplitude modulated signal.

16. The display apparatus according to claim 1, wherein said the sequence signal is a pulse width modulated signal.

17. The display apparatus according to claim 1, wherein pre-obtained waveform-data values correspond to an elapse of time during said frame, said waveform-data values becoming said digital waveform data.

18. The display apparatus according to claim 17, wherein an arithmetic expression describes said waveform-data values.

19. The display apparatus according to claim 1, wherein said backlight includes a light source configured to emit a first color light and a different light source configured to emit a different light color light other than said first color.

20. The display apparatus according to claim 19, wherein said light emission is said first color light and said different light color light.

21. The display apparatus according to claim 1, wherein said brightness is increasable from a start of the frame to a first elapsed time during the frame, said brightness remaining constant from said first elapsed time to a second elapsed time during the frame.

22. The display apparatus according to claim 21, wherein said brightness is exponentially increasable from said start of the frame to said first elapsed time.

23. The display apparatus according to claim 21, wherein said brightness is linearly increasable from said start of the frame to said first elapsed time.

24. The display apparatus according to claim 21, wherein said brightness is decreasable from said second elapsed time to an end of the frame.

25. The display apparatus according to claim 24, wherein said brightness is exponentially decreasable from said second elapsed time to said end of the frame.

26. The display apparatus according to claim 24, wherein said brightness is linearly decreasable from said second elapsed time to said end of the frame.

27. The display apparatus according to claim 1, further comprising:
a motion-amount detector configured to detect an amount of motion of an object between said frame and a prior frame, said object being in said image.

28. The display apparatus according to claim 27, wherein a characteristic of the digital waveform data includes said amount of motion.

29. The display apparatus according to claim 1, further comprising:
a computer program stored in a tangible non-transitory computer readable medium, the program configuring the display controller to execute a step of controlling the backlight to time-sequentially increase or time-sequentially decrease the brightness of the light emission.
